(19) United States
(12) Patent Application Publication
(10) Pub. No.: US 2011/0088805 A1
(43) Pub. Date: Apr. 21, 2011

(54) HEAT INSULATOR SUITABLE FOR A VEHICLE EXHAUST PIPE

(75) Inventor: Noriaki Nakagawa, Inuyama-shi (JP)

(73) Assignee: NAKAGAWA SANGYO CO., LTD., Inuyama-shi (JP)

(21) Appl. No.: 12/901,973

(22) Filed: Oct. 11, 2010

(30) Foreign Application Priority Data
Oct. 20, 2009 (JP) 2009-240964

(51) Int. Cl. F16L 9/14; B21D 51/16

(52) U.S. Cl. 138/140; 29/890.08

(57) ABSTRACT

A heat insulator is wound around an outer periphery of a vehicle exhaust pipe. The heat insulator comprises a deformable sheet-shaped heat insulating material hermetically encased in a reduced pressure state in a bag member comprised of heat-resistant metal foil.

### CROSS-REFERENCE

This application claims priority to Japanese patent application serial number 2009-240964 filed on 20 Oct. 2009, the contents of which are fully incorporated herein by reference.

### BACKGROUND OF THE INVENTION

1. Field of the Invention

The present invention relates to a heat insulator, which is suitable for a vehicle exhaust pipe in preferred applications, a vehicle exhaust pipe insulated by the heat insulator as well as methods for manufacturing the heat insulator and the vehicle exhaust pipe insulated by the heat insulator.

2. Description of the Related Art

A catalytic converter for purifying exhaust gas is typically installed in an exhaust pipe of a vehicle and the catalyst used in the catalytic converter is typically activated at a temperature of 300° C. or higher. Thus, after starting up the engine, it is necessary to rapidly increase the temperature of the catalyst to 300° C. or higher in order to promptly start the exhaust gas purification. For environmental reasons, the light-off time, i.e. the period of time after engine ignition until the catalyst is activated, has recently been set to an extremely short time and thus there is a need to supply the engine exhaust gas to the catalytic converter without reducing the temperature of the engine exhaust gas so as to promptly activate the catalyst.

One way to prevent the temperature of the engine exhaust gas from undesirably decreasing is to provide a heat insulator around the exhaust pipe so as to extend from the engine to the catalytic converter. As disclosed, e.g., in Japanese Laid-Open Patent Publication No. 09-151730, a heat insulator is proposed that has a structure in which a glass wool mat is wound around an outer periphery of the exhaust pipe and the glass wool mat is then covered by an outer pipe. Thus, a heat insulator is proposed that, when combined with the exhaust pipe, has a double pipe structure in which an air layer is formed around the outer periphery of the exhaust pipe.

However, the above-described known heat insulator still lacks sufficient heat insulating and heat retaining properties. Consequently, a heat insulator is required that has further improved thermal insulation properties so as to reduce the light-off time.

### SUMMARY OF THE INVENTION

It is an object of the present teachings to provide a heat insulator for a vehicle exhaust pipe capable of reducing the light-off time due to improved thermal insulation properties, to provide a method for manufacturing such a heat insulator, as well as to provide exhaust pipes insulated by such heat insulators.

In a first aspect of the present teachings, a heat insulator (1) for a vehicle exhaust pipe is windable or wound around an outer periphery of a vehicle exhaust pipe (2), wherein a sheet-shaped heat insulating material (5) is hermetically encased under vacuum in a bag member (4) comprised of heat-resistant metal foil(s) (41, 42).

According to such a heat insulator, a vacuum state exists inside the bag member comprised of the heat-resistant metal foil(s) that accommodate(s) the heat insulating material therein. The heat insulator for the vehicle exhaust pipe thus exhibits excellent thermal insulation properties and is capable of reducing the light-off time required to activate the catalyst after engine ignition.

A method for manufacturing such a heat insulator includes positioning the heat insulating material (5) between two heat-resistant metal foil sheets (41 and 42), superimposing the edges of the two metal foil sheets (41 and 42) to enclose the heat insulating material (5), hermetically joining the superimposed edges of the metal foil sheets (41 and 42) except at one portion (4a) to form it into a bag shape that opens at the portion (4a), evacuating the bag comprised of the metal foil sheets (41 and 42) through the opening at the portion (4a), and then closing the opening at the part (4a) by joining so as to form the bag member (4). Stainless steel foil having a thickness of 10 μm to 100 μm, preferably 20 μm to 50 μm, is preferably used as the metal foil. A non-woven fabric made of an inorganic fiber, such as a glass fiber, a basalt fiber and/or a ceramic fiber, is preferably used as the heat insulating material.

The reference numeral(s) or the set of reference characters in each pair of parentheses above denotes a correspondence to specific structures disclosed in a representative embodiment that will be further described below.

As was described above, a heat insulator for a vehicle exhaust pipe according to the present teachings is capable of exhibiting excellent thermal insulation properties and may, in certain embodiments, significantly reduce the light-off time required to activate the catalyst after engine ignition.

### BRIEF DESCRIPTION OF THE DRAWINGS

FIG. 1 is a schematic, partial cross-sectional view of a vehicle exhaust pipe provided with a representative, non-limiting heat insulator;

FIG. 2 is an enlarged cross-sectional view of a peripheral wall portion of the vehicle exhaust pipe provided with the representative, non-limiting heat insulator;

FIG. 3 is a perspective, exploded view showing a step in a representative, non-limiting process for manufacturing the heat insulator; and

FIG. 4 is a perspective view showing another step in the representative, non-limiting process for manufacturing the heat insulator.

### DETAILED DESCRIPTION OF THE PREFERRED EMBODIMENTS

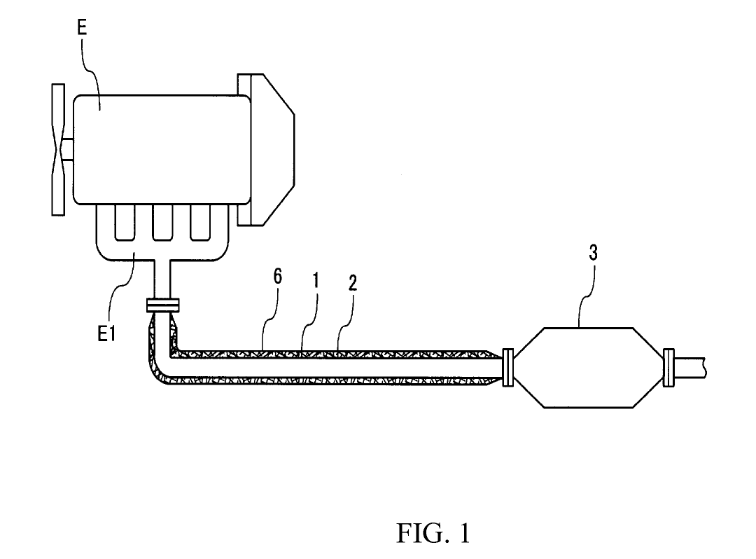

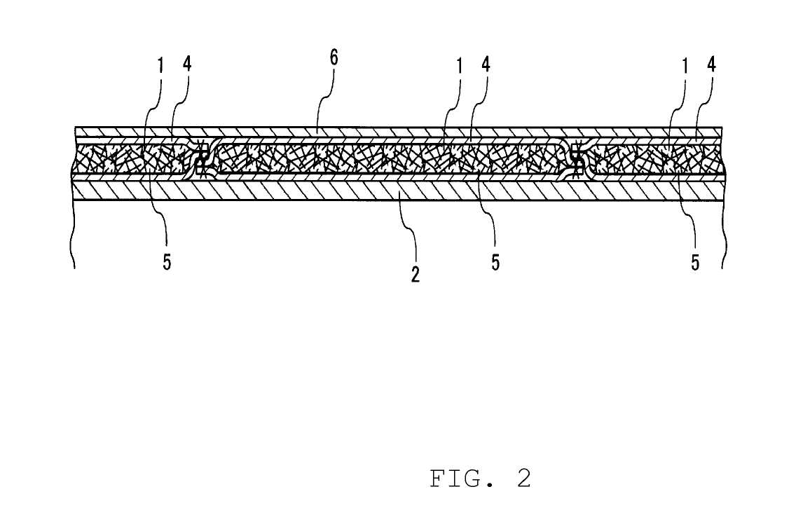

Referring to FIG. 1, a representative heat insulator 1 according to the present teachings is provided around the outer periphery of a vehicle exhaust pipe 2 which is connected to an exhaust manifold E1 of an engine E so as to extend from an upstream end to an inlet of a catalytic converter 3 provided in a middle portion of the exhaust pipe 2. FIG. 2 shows an enlarged cross-sectional view of the heat insulator 1. Each heat insulator 1 includes a bag member 4 having a certain length and being disposed along the exhaust pipe 2. As shown in FIG. 1, a plurality of heat insulators 1 are wound or wrapped around the outer periphery of the exhaust pipe 2 adjacent to each other in a sufficient number so as to cover the entire outer periphery of the exhaust pipe 2 between the exhaust manifold E1 and the catalytic converter 3. A deformable or bendable sheet-shaped heat insulating material 5 (e.g., a heat insulating mat) having a thickness of 5 mm to 15 mm is inserted into each bag member 4 and the inside of the bag member 4 is subjected to a vacuum or reduced pressure state. The plurality of heat insulators 1 having the above-described configuration are retained around the outer periphery of the vehicle exhaust pipe 2 by a metal cover body 6, which covers the respective outer surfaces of the heat insulators 1. It is noted that, if the thickness of the heat insulating material 5 is greater than 15 mm, the evacuation step (to be described below) will require a relative long time. On the other hand, if the thickness is less than 5 mm, the heat insulating effectiveness is impaired.

Each bag member 4 is comprised of or consists of heat-resistant metal foil that is preferably capable of withstanding a high temperature of at least 700 to 800° C. Stainless steel foil having both high corrosion resistance and high heat resistance is preferably used as the metal foil. In this case, the thickness of the stainless steel foil is preferably, e.g., 10 μm to 100 μm, more preferably 20 to 50 μm.

For example, a non-woven mat comprising one or more inorganic fibers exhibiting a low thermal conductivity, such as, e.g., glass fiber or ceramic fiber, can be used as the heat insulating material 5. Preferred glass fibers are glass fiber yarns available from Nitto Boseki, headquartered in Tokyo, Japan with a main branch in Fukushima, Japan, under the product name ECG. ECG has the following specifications: filament diameter 9.1 microns, filament count 200 to 800, twist 1.0/25 mm or 0.7/25 mm, Tex 33.7 to 135.0 (g/1000 m) and length per kilogram 7.4 to 29.6 (km/kg).

The degree of the vacuum or reduced pressure state existing in each bag member 4 is preferably set to about 1 to 20 Pa, more preferably 1 to 10 Pa. It is noted that if the thickness of the metal foil is greater than 100 μm, the deformability or bendability of the foil is impaired, and the evacuation requires a relatively long time. On the other hand, if the thickness is less than 10 μm, it becomes difficult to weld or sealingly join the metal foil, as will be further described below.

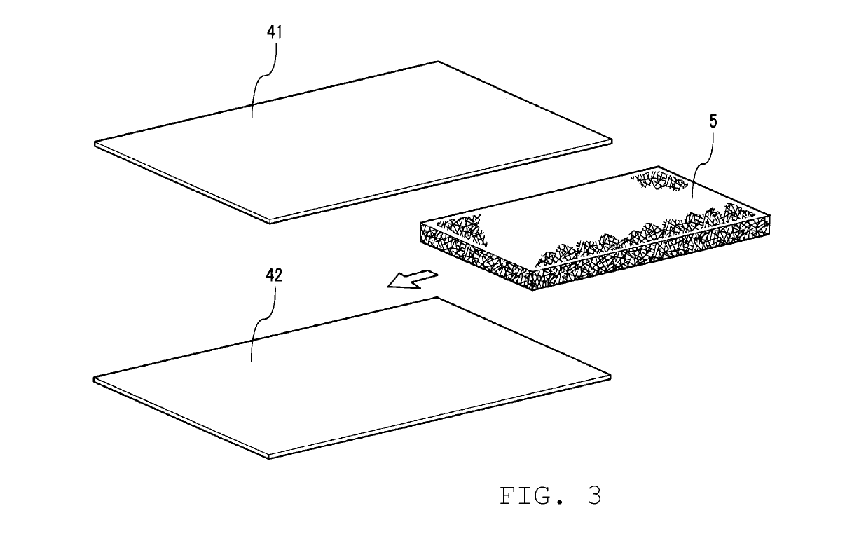

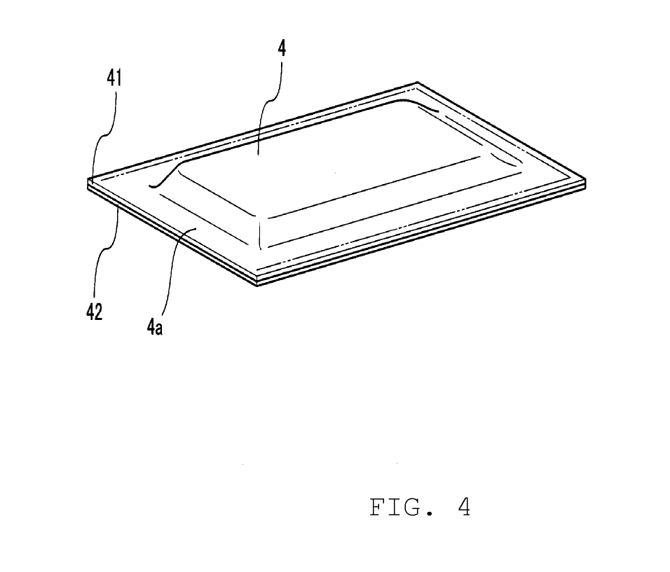

In one representative method for manufacturing a heat insulator 1 with the above-described configuration, two metal foil sheets 41 and 42 of a predetermined size are prepared and a mat or layer of heat insulating material 5 is inserted between the metal foil sheets 41 and 42, as shown in FIG. 3. After that, three edges of the two metal foil sheets 41 and 42 are joined or sealed by seam welding along three sides, i.e. excluding one side 4a (the joined/sealed portions are indicated by a chain double-dashed line in FIG. 4). Instead of seam welding, microplasma welding or fiber laser welding also may be used.

The metal foil sheets 41 and 42 are joined at the three sides to form a bag-shape. The bag-shape comprised of the metal foil sheets 41 and 42 and containing the heat insulating material 5 is placed in a vacuum chamber and is evacuated to the same reduced pressure existing in the vacuum chamber, preferably about 1 to 10 Pa, through the unjoined ends serving as an opening on the one side 4a. Thereafter, the unjoined side 4a is provisionally closed by heat sealing and the bag-shape is removed from the vacuum chamber. Lastly, the metal foil sheets 41 and 42 are securely or permanently joined or sealed along the provisionally-sealed side 4a by seam welding to form the hermetically sealed bag member 4, thereby completing the heat insulator 1. As was described above, a plurality of thus-obtained heat insulators 1 are preferably wound around the outer periphery of the vehicle exhaust pipe 2 adjacent to each other so as to extend from the exhaust manifold E1 to the catalytic converter 3. The outer circumference of the heat insulators 1 is then covered with the metal cover body 6, which retains the heat insulators 1.

As a particular example, the bag member 4 was prepared using stainless steel foil having a thickness of 50 μm and heat insulating material 5 having a thickness of 8 mm prepared from a non-woven fabric (with a density of 587 g/m²) made of a glass fiber, and the bag member 4 was evacuated to 10 Pa, thereby obtaining the heat insulator 1. The thermal conductivity of the heat insulator 1 having this configuration was measured using a heat flow meter method for a sheet (JIS-A-1412 (1994)) and was determined to be 0.0183 W/(m·K). In contrast, the thermal conductivity of the known heat insulator described in the introductory portion above was measured using the same above-described measurement method and was determined to be 0.032 W/(m·K). As can be seen from this, a heat insulator according to the present embodiment exhibits a thermal conductivity of about one-half of the known heat insulator and thus exhibits excellent thermal insulation properties as compared to the known art. When such a heat insulator is used to insulate a vehicle exhaust pipe, the light-off time can be significantly reduced.

Although the present heat insulators have been directed towards applications involving a vehicle exhaust pipe, it is understood that the heat insulators may be utilized in any application that requires insulating a structure or retaining heat within a structure, e.g., a pipe structure. For example, the present teachings also may be utilized to insulate heating ducts and/or cooling ducts.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved heat insulators, vehicle exhaust pipes and methods for manufacturing the same.

Moreover, combinations of features and steps disclosed in the above detail description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

1. A heat insulator for a vehicle exhaust pipe which is windable around an outer periphery of the vehicle exhaust pipe, the heat insulator comprising:
a deformable sheet-shaped heat insulating material hermetically encased in a reduced pressure state in a bag member comprised of heat-resistant metal foil.

2. The heat insulator according to claim 1, wherein the heat-resistant metal foil comprises stainless steel foil having a thickness of 10 μm to 100 μm.

3. The heat insulator according to claim 2, wherein the heat-resistant metal foil is capable of withstanding a temperature at least 700° C.

4. The heat insulator according to claim 3, wherein the heat insulating material comprises a non-woven fabric comprising at least one of a glass fiber, a basalt fiber and a ceramic fiber.

5. The heat insulator according to claim 4, wherein the heat insulating material has a thickness of 5 mm to 15 mm.

6. The heat insulator according to claim 5, wherein the reduced pressure state inside the bag member is between 1 to 20 Pa.

7. The heat insulator according to claim 6, wherein the heat insulator exhibits a thermal conductivity of less than or equal to 0.25 W/(m·K).

8. The heat insulator according to claim 7, wherein the thickness of the stainless steel foil is between 20 μm to 50 μm, the non-woven fabric consists of a glass fiber yarn having a Tex of 33.7 to 135.0 g/1000 m, the thickness of the non-woven fabric is between 8-12 mm, the non-woven fabric has a density of 550-600 g/m², the reduced pressure state inside the bag member is between 1 to 10 Pa and the heat insulator exhibits a thermal conductivity of less than or equal to 0.20 W/(m·K)

9. A vehicle exhaust pipe wherein at least one heat insulator according to claim 8 is wound around its outer periphery.

10. A vehicle exhaust pipe according to claim 9 having a metal cover body disposed around the at least one insulator.

11. The heat insulator according to claim 1, wherein the heat insulating material comprises a non-woven fabric comprising at least one of a glass fiber, a basalt fiber and a ceramic fiber.

12. The heat insulator according to claim 1, wherein the heat insulating material has a thickness of 5 mm to 15 mm.

13. The heat insulator according to claim 1, wherein the reduced pressure state inside the bag member is between 1 to 20 Pa.

14. The heat insulator according to claim 1, wherein the heat insulator exhibits a thermal conductivity of less than or equal to 0.25 W/(m·K).

15. A vehicle exhaust pipe wherein at least one heat insulator according to claim 1 is wound around its outer periphery.

16. A method for manufacturing the heat insulator according to claim 1, comprising:
positioning heat insulating material between two heat-resistant metal foil sheets,
superimposing edges of the two metal foil sheets to enclose the heat insulating material,
hermetically joining the edges of the metal foil sheets to form a bag shape while leaving at least one opening,
evacuating the interior of the bag shape through the opening, and
sealing the opening to form a bag member containing the heat insulating material under reduced pressure.

17. The method according to claim 16, wherein the metal foil sheets comprise stainless steel foil having a thickness of 10 μm to 100 μm.

18. The method according to claim 17, wherein the heat insulating material comprises a non-woven fabric comprising at least one of a glass fiber, a basalt fiber and a ceramic fiber.

19. The method according to claim 18, wherein the evacuation step includes reducing the pressure inside the bag shape to between 1 to 20 Pa.

20. A heat insulator comprising:
an outer shell comprised of a steel foil having a thickness of between about 10 μm to 100 μm, and
a deformable non-woven fabric mat hermetically sealed within the outer shell under a reduced pressure of between 1 to 10 Pa, the non-woven fabric mat being made of at least one of a glass fiber, a basalt fiber and a ceramic fiber.
